(19) United States
(12) Patent Application Publication
(10) Pub. No.: US 2026/0246975 A1
(43) Pub. Date: Aug. 20, 2026

(54) Methods and Apparatus of Partial Transform in Intra Block Copy Mode or Intra Template Matching Mode for Video Coding

(71) Applicant: MEDIATEK INC., Hsinchu City (TW)

(72) Inventors: Man-Shu CHIANG, Hsinchu City (TW); Yu-Cheng LIN, Hsinchu City (TW); Chih-Hsuan LO, Hsinchu City (TW); Chen-Yen LAI, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US); Yu-Wen HUANG, Hsinchu City (TW)

(21) Appl. No.: 19/472,023

(22) PCT Filed: Apr. 7, 2024
(86) PCT No.: PCT/CN2024/086359

§ 371 Date: Oct. 2, 2025

Related U.S. Application Data
(60) Provisional application No. 63/495,583, filed on Apr. 12, 2023.

(51) Int. Cl. H04N 19/61; H04N 19/159; H04N 19/176; H04N 19/18

(52) U.S. Cl. CPC H04N 19/61; H04N 19/159; H04N 19/176; H04N 19/18

(57) ABSTRACT

A method and apparatus for video coding using IBC/IntraTMP mode. According to this method, input data associated with a current block in a current picture are received. Prediction data for the current block is generated by applying Intra Block Copy or Intra Template Matching Prediction. An target transform mode to the current block is applied to derive final transformed coefficients at the encoder side or to derive reconstructed residual data at the decoder side. The target transform mode comprises subblock transform or partial transform. The subblock transform divides the current block into multiple subblocks and applies transform process to one or more subblocks as a target portion of the current block. The partial transform applies a transform process only to a target portion of the current block. The final transformed coefficients at the encoder side or the reconstructed residual data at the decoder side are provided.

### CROSS REFERENCE TO RELATED APPLICATIONS

The present invention is a non-Provisional application of and claims priority to U.S. Provisional Patent Application No. 63/495,583, filed on Apr. 12, 2023. The U.S. Provisional patent application is hereby incorporated by reference in its entirety.

### FIELD OF THE INVENTION

The present invention relates to video coding system using Intra Block Copy Mode or Intra Template Matching (IntraTMP) Mode. In particular, the present invention relates to supporting more transform modes and/or down-/up-sampling for Intra Block Copy Mode or IntraTMP Mode.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, is provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

In the present invention, methods and apparatus to improve IBC/IntraTMP modes are disclosed. For example, methods of transform coding for IBC/IntraTMP modes are proposed. For example, methods of down-/up-sampling for IBC/IntraTMP modes are proposed.

### BRIEF SUMMARY OF THE INVENTION

A method and apparatus for video coding using IBC/IntraTMP mode are disclosed. According to the method, input data associated with a current block in a current picture are received, wherein the input data comprise residual data for the current block to be encoded at an encoder side or transformed coefficients for the current block to be decoded at a decoder side, and prediction data for the current block is generated by applying Intra Block Copy or Intra Template Matching Prediction. A target transform mode is applied to the current block to derive final transformed coefficients at the encoder side or to derive reconstructed residual data at the decoder side, wherein the target transform mode comprises subblock transform or partial transform, and wherein the subblock transform divides the current block into multiple subblocks and applies transform process to one or more subblocks as a target portion of the current block, or the partial transform applies a transform process only to the target portion of the current block. The final transformed coefficients at the encoder side or the reconstructed residual data at the decoder side are provided.

In one embodiment, when the target transform mode corresponds to the subblock transform, the target portion corresponding to one of the multiple subblocks is selected as one of transform blocks to apply the transform process.

In one embodiment, a quadtree is used to divide the current block into 4 subblocks.

In one embodiment, the target portion is selected using implicit definition or explicit signalling.

In one embodiment, a binary tree is used to divide the current block into 2 subblocks. In one embodiment, the 2 subblocks are equal-sized or unequal-sized. In another embodiment, the target portion is indicated by a smaller one of unequal-sized subblocks.

In one embodiment, splitting direction, the target portion, or both are indicated by implicit definition or explicit signalling.

In one embodiment, when the target transform mode corresponds to the subblock transform, residuals in non-target portion of the current block are zeroed out or coefficients in non-target portion of the current block are zero.

In one embodiment, when the target transform mode corresponds to the partial transform, the target portion follows a pre-defined partitioning line. In one embodiment, residuals around the pre-defined partitioning line are scanned and put into the target portion at the encoder side or coefficients associated with the target portion are scanned.

In one embodiment, when the target transform mode corresponds to the partial transform, the target portion corresponds to one transform block.

In one embodiment, when the target transform mode corresponds to the partial transform, residuals in non-target portion of the current block are zeroed out or coefficients in non-target portion of the current block are zero.

In one embodiment, usage of the target transform mode is indicated as an additional transform option by explicit signalling.

In one embodiment, the target transform mode is enabled if one or more enabling conditions are satisfied. In one embodiment, said one or more enabling conditions comprise the target transform mode being available for one or more sub-modes of a target block vector coding tool. In one embodiment, the target block vector coding tool corresponds to IBC merge mode or IBC inter mode. In one embodiment, said one or more enabling conditions comprise the target transform mode being available for blocks with size condition satisfied. In one embodiment, said one or more enabling conditions comprise whether to support functionality of the target transform mode depending on high-level syntax.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates an example of CPR (Current Picture Referencing) compensation, where blocks are predicted by corresponding blocks in the same picture.

FIG. 3 illustrates an example of search area used for Intra template matching.

FIG. 4 illustrates an example of use of IntraTMP block vector for IBC block.

FIG. 5 illustrates an example of Low-Frequency Non-Separable Transform (LFNST) process.

FIG. 6 shows position-dependent transform core selection for SBT.

FIG. 7A illustrates an example of BV adjustment for horizontal flip.

FIG. 7B illustrates an example of BV adjustment for vertical flip.

FIG. 8 illustrates an example of the current block split into 4 transform blocks by a quadtree, where the target portion is indicated as one area (indicated as a shaded area) in the current block.

FIG. 9 illustrates an example of down-sampling IBC mode.

FIG. 10 illustrates a flowchart of an exemplary video coding system that uses multiple transforms for IBC/IntraTMP mode according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### Intra-Block-Copy (IBC) Mode

Motion Compensation, one of the key technologies in hybrid video coding, explores the pixel correlation between adjacent pictures. It is generally assumed that, in a video sequence, the patterns corresponding to objects or background in a frame are displaced to form corresponding objects in the subsequent frame or correlated with other patterns within the current frame. With the estimation of such displacement (e.g. using block matching techniques), the pattern can be mostly reproduced without the need to re-code the pattern. Similarly, block matching and copy has also been tried to allow selecting the reference block from the same picture as the current block. It was observed to be inefficient when applying this concept to camera captured videos. Part of the reasons is that the textual pattern in a spatial neighbouring area may be similar to the current coding block, but usually with some gradual changes over the space. It is difficult for a block to find an exact match within the same picture in a video captured by a camera. Accordingly, the improvement in coding performance is limited.

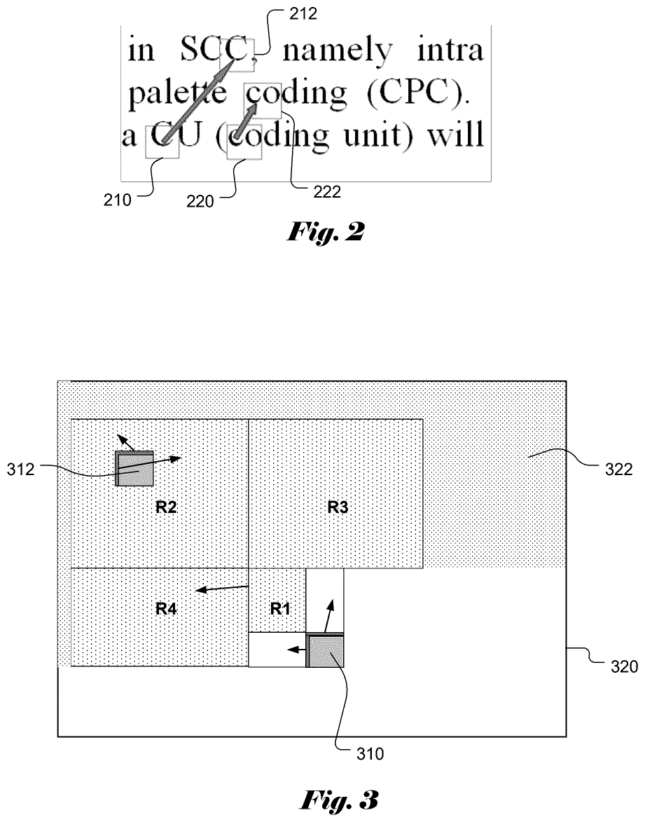

However, the situation for spatial correlation among pixels within the same picture is different for screen contents. For a typical video with texts and graphics, there are usually repetitive patterns within the same picture. Hence, intra (picture) block compensation has been observed to be very effective. A new prediction mode, i.e., the intra block copy (IBC) mode or called current picture referencing (CPR), has been introduced for screen content coding to utilize this characteristic. In the CPR mode, a prediction unit (PU) is predicted from a previously reconstructed block within the same picture. Further, a displacement vector (called block vector or BV) is used to indicate the relative displacement from the position of the current block to that of the reference block. The prediction errors are then coded using transformation, quantization and entropy coding. An example of IBC compensation is illustrated in FIG. 2, where block 212 is a corresponding block for block 210, and block 222 is a corresponding block for block 220. In this technique, the reference samples correspond to the reconstructed samples of the current decoded picture prior to in-loop filter operations, both deblocking and sample adaptive offset (SAO) filters in HEVC.

The very first version of IBC was proposed in JCTVC-M0350 (Budagavi et al., AHG8: Video coding using Intra motion compensation, Joint Collaborative Team on Video Coding (JCT-VC) of ITU-T SG16 WP3 and ISO/IEC JTC 1/SC 29/WG11, 13th Meeting: Incheon, KR, 18-26 Apr. 2013, Document: JCTVC-M0350) to the HEVC Range Extensions (RExt) development. In this version, the IBC compensation was limited to be within a small local area, with only 1-D block vector and only for block size of 2N×2N. Later, a more advanced IBC design has been developed during the standardization of HEVC SCC (Screen Content Coding).

### Intra Template Matching Prediction

Intra template matching prediction (IntraTMP) is a special intra prediction mode that copies the best prediction block from the reconstructed part of the current frame, whose L-shaped template matches the current template. For a predefined search range, the encoder searches for the most similar template matched with the current template in a reconstructed part of the current frame and uses the corresponding block as a prediction block. The encoder then signals the usage of this mode, and the same prediction operation is performed at the decoder side.

The prediction signal is generated by matching the L-shaped causal neighbour of the current block with another block in a predefined search area in FIG. 3 consisting of:
R1: all or any subset of current CTU
R2: top-left CTU
R3: above CTU
R4: left CTU

In FIG. 3, the current block 310 in R1 is matched with the corresponding block 312 in R2. The templates for the current block and the matched block are shown as darker-colour L-shaped areas. Area 322 corresponds to reconstructed region in the current picture 320. Sum of absolute differences (SAD) is used as a cost function. Within each region, the decoder searches for the template that has least SAD with respect to the current one and uses its corresponding block as a prediction block.

The dimensions of all regions (SearchRange_w, SearchRange_h) are set proportional to the block dimension (BlkW, BlkH) to have a fixed number of SAD comparisons per pixel. That is:

$$SearchRange\_w = a * BlkW ,$$

$$SearchRange\_h = a * BlkH ,$$

where ‘a’ is a constant that controls the gain/complexity trade-off. In practice, ‘a’ is equal to 5.

To speed-up the template matching process, the search range of all search regions is subsampled by a factor of 2. This leads to a reduction of template matching search by 4. After finding the best match, a refinement process is performed. The refinement is done via a second template matching search around the best match with a reduced range. The reduced range is defined as min(BlkW, BlkH)/2.

The Intra template matching tool is enabled for CUs with size less than or equal to 64 in width and height. This maximum CU size for Intra template matching is configurable.

The Intra template matching prediction mode is signalled at CU level through a dedicated flag when DIMD (Decoder-side Intra Mode Derivation) is not used for current CU.

### IntraTMP Derived Block Vector Candidates for IBC

In this method, block vector (BV) derived from the intra template matching prediction (IntraTMP) is used for intra block copy (IBC). The stored IntraTMP BV of the neighbouring blocks along with IBC BV are used as spatial BV candidates in IBC candidate list construction.

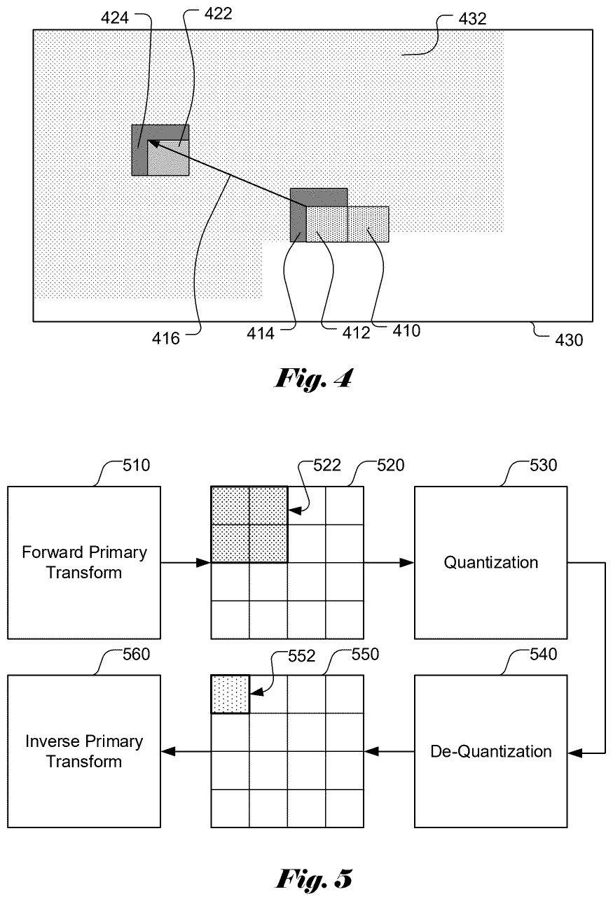

IntraTMP block vector is stored in the IBC block vector buffer and, the current IBC block can use both IBC BV and IntraTMP BV of neighbouring blocks as BV candidates for IBC BV candidate list as shown in FIG. 4.

In FIG. 4, block 410 corresponds to the current block and block 412 corresponds to a neighbouring IntraTMP block. The IntraTMP BV 416 is used to locate the best matching block 422 according to the matching cost between template 424 and template 414. Area 432 corresponds to reconstructed region in the current picture 430. IntraTMP block vectors are added to IBC block vector candidate list as spatial candidates.

IntraTMP block vectors are added to IBC block vector candidate list as spatial candidates.

### Multiple Transform Selection (MTS) for Core Transform

In addition to DCT-II which has been employed in HEVC, a Multiple Transform Selection (MTS) scheme is used for residual coding both inter and intra coded blocks. It uses multiple selected transforms from the DCT8/DST7. The newly introduced transform matrices are DST-VII and DCT-VIII. Table 1 shows the basis functions of the selected DST/DCT.

TABLE 1
Transform basis functions of DCT-II/VIII and DSTVII for N-point input

| Transform Type | Basis function Tᵢ(j), i, j = 0, 1, ... , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , ω 0 = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DST-VII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In order to keep the orthogonality of the transform matrix, the transform matrices are quantized more accurately than the transform matrices in HEVC. To keep the intermediate values of the transformed coefficients within the 16-bit range, after horizontal and after vertical transform, all the coefficients are to have 10-bit accuracy.

In order to control MTS scheme, separate enabling flags are specified at SPS (Sequence Parameter Set) level for intra and inter, respectively. When MTS is enabled at SPS, a CU level flag is signalled to indicate whether MTS is applied or not. Here, MTS is applied only for luma. The MTS signalling is skipped when one of the below conditions is applied:
The position of the last significant coefficient for the luma TB is less than 1 (i.e., DC only),
The last significant coefficient of the luma TB is located inside the MTS zero-out region.

If MTS CU flag is equal to zero, then DCT2 is applied in both directions. However, if MTS CU flag is equal to one, then two other flags are additionally signalled to indicate the transform types for the horizontal and vertical directions, respectively. Transform and signalling mapping table as shown in Table 2.

TABLE 2

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of large size DST-7 and DCT-8, high frequency transform coefficients are zeroed out for the DST-7 and DCT-8 blocks with size (width or height, or both width and height) equal to 32. Only the coefficients within the 16×16 lower-frequency region are retained.

As in HEVC, the residual of a block can be coded with transform skip mode. To avoid the redundancy of syntax coding, the transform skip flag is not signalled when the CU level MTS_CU_flag is not equal to zero. Note that implicit MTS transform is set to DCT2 when LFNST. Also, the implicit MTS can be still enabled when MTS is enabled for inter coded blocks.

### Low-Frequency Non-Separable Transform (LFNST)

In VVC, LFNST is applied between forward primary transform and quantization (at the encoder side) and between de-quantization and inverse primary transform (at the decoder side) as shown in FIG. 5. As shown in FIG. 5, after Forward Primary Transform 510, Forward Low-Frequency Non-Separable Transform LFNST 520 is applied to top-left region 522 of the Forward Primary Transform output, for example, 16 coefficients for 4×4 forward LFNST and/or 64 coefficients for 8×8 forward LFNST. In LFNST, 4×4 non-separable transform or 8×8 non-separable transform is applied according to block size. For example, 4×4 LFNST is applied for small blocks (i.e., min (width, height)<8) and 8×8 LFNST is applied for larger blocks (i.e., min (width, height)>4). After LFNST, the transform coefficients are quantized by Quantization 530. To reconstruct the input signal, the quantized transform coefficients are de-quantized using De-Quantization 540 to obtain the de-quantized transform coefficients. Inverse LFNST 550 is applied to the top-left region 552 (8 coefficients for 4×4 inverse LFNST or 16 coefficients for 8×8 inverse LFNST). After invers LFNST, inverse Primary Transform 560 is applied to recover the input signal.

Application of a non-separable transform, which is being used in LFNST, is described as follows using input as an example. To apply 4×4 LFNST, the 4×4 input block X

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{21} & {X}_{22} & {X}_{23} \\ {X}_{30} & {X}_{31} & {X}_{32} & {X}_{33}\end{matrix} ]$$

is first represented as a vector \vec{X}:

$$\vec{X} = {[ {X}_{00} {X}_{01} {X}_{02} {X}_{03} {X}_{10} {X}_{11} {X}_{12} {X}_{130} {X}_{20} {X}_{21} {X}_{22} {X}_{23} {X}_{30} {X}_{31} {X}_{32} {X}_{33} ]}^{T}$$

The non-separable transform is calculated as \vec{F}=T·\vec{X}, where \vec{F} indicates the transform coefficient vector, and T is a 16×16 transform matrix. The 16×1 coefficient vector \vec{F} is subsequently re-organized as 4×4 block using the scanning order for that block (horizontal, vertical or diagonal). The coefficients with smaller index will be placed with the smaller scanning index in the 4×4 coefficient block.

### Reduced Non-Separable Transform

LFNST (low-frequency non-separable transform) is based on direct matrix multiplication approach to apply non-separable transform so that it is implemented in a single pass without multiple iterations. However, the non-separable transform matrix dimension needs to be reduced to minimize computational complexity and memory space to store the transform coefficients. Hence, reduced non-separable transform (or RST) method is used in LFNST. The main idea of the reduced non-separable transform is to map an N (N is commonly equal to 64 for 8×8 NSST) dimensional vector to an R dimensional vector in a different space, where N/R (R<N) is the reduction factor. Hence, instead of N×N matrix, RST matrix becomes an R×N matrix as follows:

$${T}_{R \times N} = [ \begin{matrix}{t}_{11} & {t}_{11} & {t}_{11} & & {t}_{11} \\ {t}_{21} & {t}_{21} & {t}_{21} & … & {t}_{21} \\ & ⋮ & & ⋱ & ⋮ \\ {t}_{R 1} & {t}_{R 1} & {t}_{R 1} & … & {t}_{R 1}\end{matrix} ]$$

where the R rows of the transform are R bases of the N dimensional space.

The inverse transform matrix for RST is the transpose of its forward transform. For 8×8 LFNST, a reduction factor of 4 is applied, and 64×64 direct matrix, which is conventional 8×8 non-separable transform matrix size, is reduced to 16×48 direct matrix. Hence, the 48×16 inverse RST matrix is used at the decoder side to generate core (primary) transform coefficients in 8×8 top-left regions. When 16×48 matrices are applied instead of 16×64 with the same transform set configuration, each of which takes 48 input data from three 4×4 blocks in a top-left 8×8 block excluding right-bottom 4×4 block. With the help of the reduced dimension, memory usage for storing all LFNST matrices is reduced from 10 KB to 8 KB with reasonable performance drop. In order to reduce complexity LFNST is restricted to be applicable only if all coefficients outside the first coefficient sub-group are non-significant. Hence, all primary-only transform coefficients have to be zero when LFNST is applied. This allows a conditioning of the LFNST index signalling on the last-significant position, and hence avoids the extra coefficient scanning in the current LFNST design, which is needed for checking for significant coefficients at specific positions only. The worst-case handling of LFNST (in terms of multiplications per pixel) restricts the non-separable transforms for 4×4 and 8×8 blocks to 8×16 and 8×48 transforms, respectively. In those cases, the last-significant scan position has to be less than 8 when LFNST is applied, for other sizes less than 16. For blocks with a shape of 4×N and Nx4 and N>8, the proposed restriction implies that the LFNST is now applied only once, and that to the top-left 4×4 region only. As all primary-only coefficients are zero when LFNST is applied, the number of operations needed for the primary transforms is reduced in such cases. From encoder perspective, the quantization of coefficients is remarkably simplified when LFNST transforms are tested. A rate-distortion optimized quantization has to be done at maximum for the first 16 coefficients (in scan order), the remaining coefficients are enforced to be zero.

### LFNST Transform Selection

There are totally 4 transform sets and 2 non-separable transform matrices (kernels) per transform set are used in LFNST. The mapping from the intra prediction mode to the transform set is pre-defined as shown in Table 3. If one of three CCLM modes (INTRA_LT_CCLM, INTRA_T_CCLM or INTRA_L_CCLM) is used for the current block (81<=predModeIntra<=83), transform set 0 is selected for the current chroma block. For each transform set, the selected non-separable secondary transform candidate is further specified by the explicitly signalled LFNST index. The index is signalled in a bit-stream once per Intra CU after transform coefficients.

TABLE 3
Transform selection table

| | Tr. set |
|---|---|
| IntraPredMode | index |
| IntraPredMode < 0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

LFNST Index Signalling and Interaction with Other Tools

Since LFNST is restricted to be applicable only if all coefficients outside the first coefficient sub-group are non-significant, LFNST index coding depends on the position of the last significant coefficient. In addition, the LFNST index is context coded but does not depend on intra prediction mode, and only the first bin is context coded. Furthermore, LFNST is applied for intra CU in both intra and inter slices, and for both luma and chroma. If a dual tree is enabled, LFNST indices for luma and chroma are signalled separately. For inter slice (the dual tree is disabled), a single LFNST index is signalled and used for both luma and chroma.

Considering that a large CU greater than 64×64 is implicitly split (TU tiling) due to the existing maximum transform size restriction (64×64), an LFNST index search could increase data buffering by four times for a certain number of decode pipeline stages. Therefore, the maximum size that LFNST allowed is restricted to 64×64. Note that LFNST is enabled with DCT2 only. The LFNST index signalling is placed before MTS index signalling.

The use of scaling matrices for perceptual quantization is not evident that the scaling matrices that are specified for the primary matrices may be useful for LFNST coefficients. Hence, the uses of the scaling matrices for LFNST coefficients are not allowed. For single-tree partition mode, chroma LFNST is not applied.

### Subblock Transform (SBT)

In VTM (VVC Test Model) software, subblock transform is introduced for an inter-predicted CU. In this transform mode, only a sub-part of the residual block is coded for the CU. When inter-predicted CU with cu_cbf equal to 1, cu_sbt_flag may be signalled to indicate whether the whole residual block or a sub-part of the residual block is coded. In the former case, inter MTS information is further parsed to determine the transform type of the CU. In the latter case, a part of the residual block is coded with inferred adaptive transform and the other part of the residual block is zeroed out.

When SBT is used for an inter-coded CU, SBT type and SBT position information are signalled in the bitstream. There are two SBT types and two SBT positions. For SBT-V (or SBT-H), the TU width (or height) may be equal to half of the CU width (or height) or ¼ of the CU width (or height), resulting in 2:2 split or 1:3/3:1 split. The 2:2 split is like a binary tree (BT) split while the 1:3/3:1 split is like an asymmetric binary tree (ABT) split. In ABT splitting, only the small region contains the non-zero residual. If one dimension of a CU is 8 in luma samples, the 1:3/3:1 split along that dimension is not allowed. There are at most 8 SBT modes for a CU.

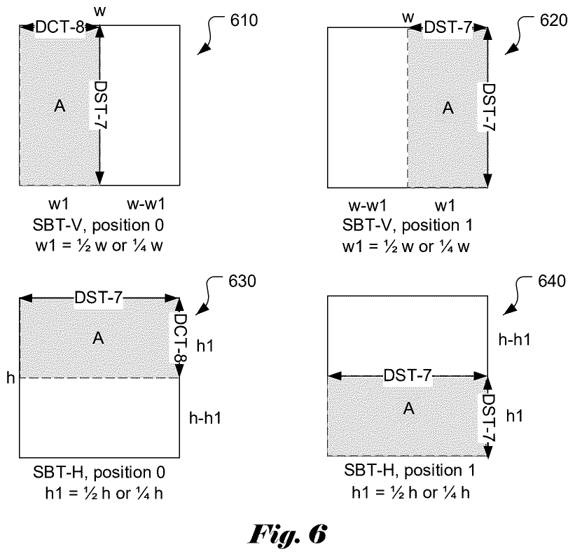

Position-dependent transform core selection is applied on luma transform blocks in SBT-V and SBT-H (chroma TB always using DCT-2). The two positions of SBT-H (630 and 640) and SBT-V (610 and 620) are associated with different core transforms as shown in FIG. 6. More specifically, the horizontal and vertical transforms for each SBT position is specified in FIG. 6. For example, the horizontal and vertical transforms for SBT-V position 0 is DCT-8 and DST-7, respectively. When one side of the residual TU is greater than 32, the transform for both dimensions (or directions) is set as DCT-2. Therefore, the subblock transform jointly specifies the TU tiling, cbf, and horizontal and vertical core transform type of a residual block.

The SBT is not applied to the CU coded with combined inter-intra mode.

### Block Differential Pulse Coded Modulation (BDPCM)

VVC supports block differential pulse coded modulation (BDPCM) for screen content coding. At the sequence level, a BDPCM enable flag is signalled in the SPS; this flag is signalled only if the transform skip mode (as appeared in the several sections or embodiments) is enabled in the SPS.

When BDPCM is enabled, a flag is transmitted at the CU level if the CU size is smaller than or equal to MaxTsSize by MaxTsSize in terms of luma samples and if the CU is intra coded, where MaxTsSize is the maximum block size for which the transform skip mode is allowed. This flag indicates whether regular intra coding or BDPCM is used. If BDPCM is used, a BDPCM prediction direction flag is transmitted to indicate whether the prediction is horizontal or vertical. Then, the block is predicted using the regular horizontal or vertical intra prediction process with unfiltered reference samples. The residual is quantized and the difference between each quantized residual and its predictor (i.e. the previously coded residual of the horizontal or vertical (depending on the BDPCM prediction direction) neighbouring position) is coded.

For a block of size M (height)×N (width), let r_{i,j}, 0≤i≤M−1, 0≤j≤N−1, be the prediction residual. Let Q(r_{i,j}), 0≤i≤M−1, 0≤j≤N−1, denote the quantized version of the residual r_{i,j}. BDPCM is applied to the quantized residual values, resulting in a modified M×N array \tilde{R} with elements \tilde{r}_{i,j}, where \tilde{r}_{i,j} is predicted from its neighbouring quantized residual value. For vertical BDPCM prediction mode, for 0≤j≤N−1, the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} ,$$

For horizontal BDPCM prediction mode, for 0≤i≤(M−1), the following is used to derive \tilde{r}_{i,j}:

$${\tilde{r}}_{i , j} = \{ \begin{matrix}Q ( {r}_{i , j} ) , & j = 0 \\ Q ( {r}_{i , j} ) - Q ( {r}_{i , ( j - 1 )} ) , & 1 \leq j \leq ( N - 1 )\end{matrix} .$$

At the decoder side, the above process is reversed to compute Q(r_{i,j}), 0≤i≤(M−1), 0≤j≤N−1, as follows:

$$Q ( {r}_{i , j} ) = {\sum }_{k = 0}^{i} {\tilde{r}}_{k , j} , if vertical BDPCM is used$$

$$Q ( {r}_{i , j} ) = {\sum }_{k = 0}^{j} {\tilde{r}}_{i , k} , if horizontal BDPCM is used$$

The inverse quantized residuals, Q⁻¹(Q(r_{i,j})), are added to the intra block prediction values to produce the reconstructed sample values.

The predicted quantized residual values \tilde{r}_{i,j} are sent to the decoder using the same residual coding process as that in transform skip mode residual coding. For lossless coding, if slice_ts_residual_coding_disabled_flag is set to 1, the quantized residual values are sent to the decoder using regular transform residual coding. In terms of the MPM mode for future intra mode coding, horizontal or vertical prediction mode is stored for a BDPCM-coded CU if the BDPCM prediction direction is horizontal or vertical, respectively. For deblocking, if both blocks on the sides of a block boundary are coded using BDPCM, then that particular block boundary is not deblocked.

### Reconstruction-Reordered IBC (RR-IBC)

A Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

Two flip methods, horizontal flip and vertical flip, are supported for RR-IBC coded blocks. A syntax flag is firstly signalled for an IBC AMVP coded block, indicating whether the reconstruction is flipped, and if it is flipped, another flag is further signalled specifying the flip type. For IBC merge, the flip type is inherited from neighbouring blocks, without syntax signalling. Considering the horizontal or vertical symmetry, the current block and the reference block are normally aligned horizontally or vertically. Therefore, when a horizontal flip is applied, the vertical component of the BV is not signalled and inferred to be equal to 0. Similarly, the horizontal component of the BV is not signalled and inferred to be equal to 0 when a vertical flip is applied.

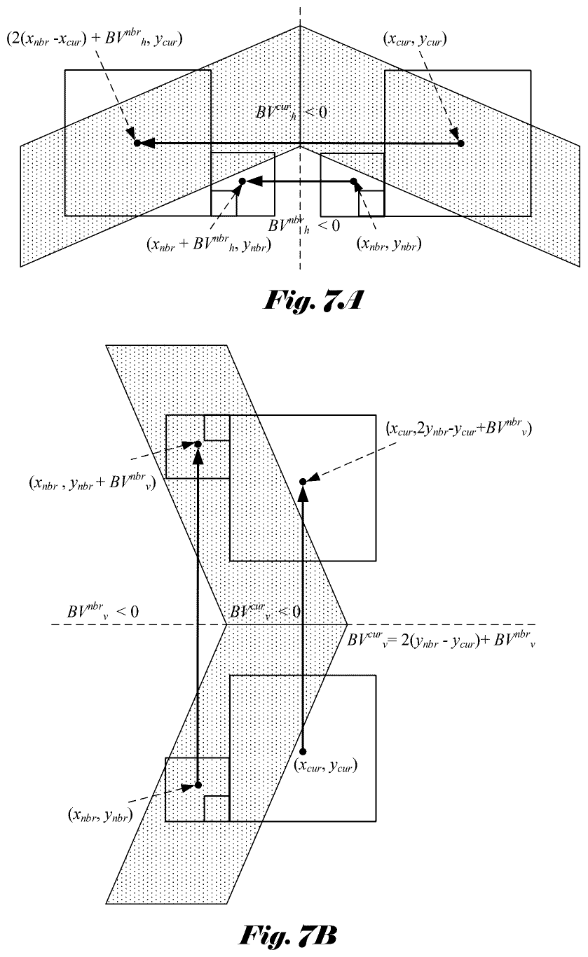

To better utilize the symmetry property, a flip-aware BV adjustment approach is applied to refine the block vector candidate. For example, as shown in FIG. 7A and FIG. 7B, (x_{nbr}, y_{nbr}) and (x_{cur}, y_{cur}) represent the coordinates of the center sample of the neighbouring block and the current block, respectively, BV^{nbr} and BV^{cur} denotes the BV of the neighbouring block and the current block, respectively. Instead of directly inheriting the BV from a neighbouring block, the horizontal component of BV^{cur} is calculated by adding a motion shift to the horizontal component of BV^{nbr} (denoted as BV^{nbr}ₕ) in case that the neighbouring block is coded with a horizontal flip (as shown in FIG. 7A), i.e., BV^{cur}ₕ=2(x_{nbr}−x_{cur})+BV^{nbr}ₕ. Similarly, the vertical component of BV^{cur} is calculated by adding a motion shift to the vertical component of BV^{nbr} (denoted as BV^{nbr}ᵥ) in case that the neighbouring block is coded with a vertical flip (as shown in FIG. 7B), i.e., BV^{cur}ᵥ=2(y_{nbr}−y_{cur})+BV^{nbr}ᵥ.

IBC Merge Mode with Block Vector Differences (IBC-MBVD)

Affine-MMVD and GPM-MMVD have been adopted to ECM as an extension of regular MMVD mode. It is natural to extend the MMVD mode to the IBC merge mode.

In IBC-MBVD, the distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding. The MBVD index is binarized by the Rice code with the parameter equal to 1.

An IBC-MBVD coded block does not inherit flip type from a RR-IBC coded neighbour block.

### IBC-LIC

In JVET-AC0112 (Yang Wang, et. al., “EE2-3.6: IBC-CIIP, IBC-GPM, and IBC-LIC”, Joint Video Experts Team (JVET) of ITU-T SG 16 WP 3 and ISO/IEC JTC 1/SC 29, 29th Meeting, by teleconference, 11-20 Jan. 2023, Document: JVET-AC0112), IBC-LIC is adopted in ECM (Enhanced Compression Model). Intra block copy with local illumination compensation (IBC-LIC) is a coding tool which compensates the local illumination variation within a picture between the CU coded with IBC and its prediction block with a linear equation. The parameters of the linear equation are derived same as LIC for inter prediction except that the reference template is generated using block vector in IBC-LIC. IBC-LIC can be applied to IBC AMVP mode and IBC merge mode. IBC AMVP (IBC with Advanced Motion Vector Prediction Mode) corresponds to the IBC mode that directly signals motion vector predictor index, and motion vector difference if necessary. The name IBC AMVP is used in this disclosure. For IBC AMVP mode, an IBC-LIC flag is signalled to indicate the use of IBC-LIC. For IBC merge mode, the IBC-LIC flag is inferred from the merge candidate.

### IBC-GPM

In JVET-AC0112, IBC-GPM is adopted in ECM. Intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. An intra prediction mode (IPM) candidate list is constructed using the same method as GPM with inter and intra prediction for intra prediction, and the IPM candidate list size is pre-defined as 3. There are 48 geometry partitioning modes in total, which are divided into two geometry partitioning mode sets as follows:

TABLE 4
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 5
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

### IBC-CIIP

In JVET-AC0112, IBC-CIIP is adopted in ECM. Combined intra block copy and intra prediction (IBC-CIIP) is a coding tool for a CU which uses IBC prediction (for example, IBC prediction from IBC with merge mode) and intra prediction (for example, intra prediction from planar or DC mode) to obtain two prediction signals, and the two prediction signals are weighted summed to generate the final prediction as follows:

$$P = ( {w}_{i b c} * {P}_{i b c} + ( ( 1 << shift ) - {w}_{ibc} ) * {P}_{intra} + ( 1 << ( shift - 1 ) ) ) >> shift ,$$

wherein P_{ibc} and Pᵢₙₜᵣₐ denote the IBC prediction signal and intra prediction signal, respectively. (w_{ibc}, shift) are set equal to (13, 4) and (1, 1) for IBC merge mode and IBC AMVP mode.

In order to improve the coding performance of IBC/IntraTMP mode, multiple transform methods and/or down-/up-sampling for IBC/IntaTMP coded blocks are disclosed.

In this invention, when a scheme of intra block copy is used to generate the predictors for the current block, multiple transform methods, for example, multiple transform modes, are proposed to improve the coding efficiency. The scheme of intra block copy means indicating (referencing) a pre-defined set of the reconstructed samples in the current picture by block vectors for the current block and/or template matching. For example, the current block refers to a coding unit containing only luma coding block, only chroma coding blocks (including Cb coding block and Cr coding block), and/or both luma and chroma coding blocks. When the current block is coded with IBC or intra TMP, the scheme of intra block copy is used and the predictors for the current block are generated by copying and/or referencing an already-reconstructed set of the reconstructed samples in the current picture where the set may have the same size as the current block. At the encoder, the residuals for the current block are calculated as the difference between the original source of the current block and the predictors for the current block. In a conventional coding system, the residuals from IBC and/or IntraTMP mode are processed only using transform mode DCT-II.

According to embodiments of the present invention, one or more proposed transform modes are applied to the residuals or temporary-transformed coefficients related to the residuals to get improved transformed coefficients. The improved transform coefficients may be the final transform coefficients used in the following residual coding process and (after quantizing) encoded in bitstream to the decoder. Alternatively, the improved transform coefficients may be another temporary-transformed coefficients, which will be further transformed by a subsequent transform process. At the decoder, the final transform coefficients are parsed from the bitstream and recovered (by dequantizing). If any subsequent transform process is applied after the proposed transform mode at the encoder, the final transform coefficients are first inverse transformed by the subsequent transform process (to get the improved transform coefficients) and then inverse transformed by the proposed transform modes. Then, after finishing all inverse transform process, the residuals for the current block are obtained and can be used to reconstruct the current block by adding with the predictors for the current block. In one embodiment, the proposed transform mode refers to a target transform mode which may be selected from a transform set. For example, the transform set comprising two or more transform modes. For another example, the transform set and/or transform selection is used by or unified with other non-block-vector coding tools such as inter coding tools which use motion information for prediction generation and/or intra coding tools which use the spatial reference samples with a DC, planar, or angular prediction mode for prediction generation. For example, the transform set comprises transform skip, primary transform, secondary transform, or a combination of the above-mentioned transforms. For an example of a transform skip mode, no transform operation and/or no transform kernel is required. For an example of a primary transform, it is applied to the residuals at the encoder, and/or it is applied to the final transform coefficients (if the final transform coefficients are generated using the primary transform only) or temporary-transformed coefficients (if the final transform coefficients are first inverse transformed by other transform process) at the decoder. The primary transform can be separable or non-separable. An example of the separable primary transform is MTS which determines the transform types explicitly and/or implicitly. The explicit transform selection can use an MTS index to select the transform types for horizontal and/or vertical directions. The implicit transform selection can use position-dependent transform core selection. For an example of a secondary transform, it is applied to the temporary-transformed coefficients at the encoder, and/or it is applied to the final transform coefficients (if the final transform coefficients are generated using the primary transform and the secondary transform) at the decoder. The secondary transform can be separable or non-separable. An example of the non-separable secondary transform is LFNST or any RST variation. In another embodiment, the proposed transform mode is used as an additional transform option as indicated by an explicit syntax. For an example of using a MTS-type transform mode for the current block which uses block vectors to generate prediction, the proposed transform option is applied and/or refers to using the MTS-type transform mode for the current block. The proposed transform option is in addition to the conventional option which only uses DCT-II transform mode.

In one embodiment, the proposed transform mode refers to a partial transform setting. The following is an example of applying the proposed methods on the residuals (at the encoder). Note that the proposed method can be applied to temporary-transformed coefficients at the encoder and/or perform corresponding operations at the decoder. The partial transform setting on the encoder means to (1) only keep a target portion of residuals in the current block, (2) zero out the remaining residuals (not including in the pre-defined portion) in the current block, and/or (3) transform the target portion of residuals in the current block. The partial transform setting on the decoder means to (1) receive the transformed coefficients (related to the target portion of residuals) for the current block, and/or (2) inverse-transform the receiving transformed coefficients and get back the residuals for the current block. For (1), coefficients in non-target portion of the current block may be or should be zero.

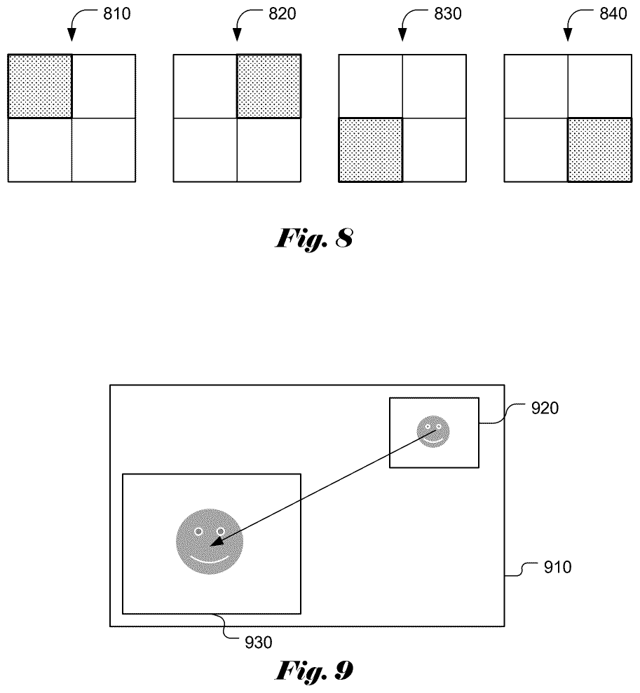

In one sub-embodiment, to define the target portion, the current block is split into multiple transform blocks following a splitting rule and the target portion refers to one of the transform blocks. For example, the splitting rule is to apply quad-tree splitting to the current block as shown in FIG. 8.

Then the current block is split into 4 transform blocks. The target portion is indicated as one of the 4 transform blocks by implicit definition or explicit signalling. That is, the target portion is indicated as one area (which is indicated as a shaded area and/or which can be viewed as a transform block of the current block) in the current block by implicit definition or explicit signalling. In the quad-tree case, the target portion has four possible locations. The first, second, third, and fourth locations (shown in 810, 820, 830, and 840) are the target portions at the top-left area, top-right area, bottom-left area, bottom-right area of the current block, respectively. For another example, the splitting rule is to apply 2:2 binary-tree splitting to the current block. Then the current block is split into 2 equal-size transform blocks by a vertical splitting or horizontal splitting. The target portion is indicated as one of the 2 transform blocks. The splitting direction (vertical or horizontal) and/or portion indication depends on implicit definition or explicit signalling. For another example, the splitting rule is to apply 1:3 binary-tree splitting to the current block. Then the current block is split into 2 transform blocks with size 1:3 by a vertical splitting or horizontal splitting. The target portion is indicated as the smaller one of the 2 transform blocks. If the vertical splitting is used, the 2 transform blocks (at left side and right side) have the size ratio 1:3 or 3:1. If the horizontal splitting is used, the 2 transform blocks (at above side and bottom side) have the size ratio 1:3 or 3:1. The splitting direction (vertical or horizontal) and/or the size ratio (1:3 or 3:1, referring the 1 in the size ratio as the target portion) depends on implicit definition or explicit signalling. The transform types (any pre-defined MTS types) for the transform block of target portion are decided according to the splitting direction and/or portion indication. The transform type can be selected from DCT-II and/or any MTS types and/or transform skip mode. For the case of 2 transform blocks, an example of the indications is shown in Table 6.

TABLE 6
An example of transform type selection for the target portion

| | Portion indication | | |
|---|---|---|---|
| | (for example, | | |
| Horizontal | referring which of | | |
| splitting or | the 2 transform | Horizontal | Vertical |
| not | blocks is transformed) | transform | transform |
| 0 | 0 | DCT-VIII | DST-VII |
| 0 | 1 | DST-VII | DST-VII |
| 1 | 0 | DST-VII | DCT-VIII |
| 1 | 1 | DST-VII | DST-VII |

For another example of 4 transform blocks, different portion indications refer to different combinations of transform modes. Portion indication 0 to 3 may refer {DCT-VIII, DCT-VIII}, {DST-VII, DCT-VIII}, {DCT-VIII, DST-VII}, {DST-VII, DST-VII} for {horizontal, vertical} or any other combinations of DCT-VIII and DST-VII.

In another sub-embodiment, to define the target portion, the residuals around a partitioning line are scanned and put into the target portion. At the decoder, coefficients associated with the target portion are scanned. For example, the partitioning line is used to divide the current block into multiple (e.g. 2) prediction blocks and use different block vectors to generate the predictors for each prediction block and combine the predictors from multiple prediction blocks as the predictors around the partitioning line. The residuals calculated by the predictors approaching the partitioning line are scanned and put into a square transform block following the scanning order. At the decoder, coefficients associated with the square transform block as a target portion are scanned following the scanning order.

In another sub-embodiment, the current block is not split into multiple transform blocks by the proposed partial transform setting. The target portion is not referring to an individual transform block and is referring to a subset of the residuals of the current block. For example, the target portion refers to the first N residuals or coefficients in the current block following diagonal scanning. For another example, the target portion refers to the first half of the current block by a vertical or horizontal splitting. Specifically, the target portion refers to the first half residuals or coefficients of the current block by a vertical or horizontal splitting.

In another sub-embodiment, the proposed methods under the same root embodiment can be optional modes. For example, a flag is signalled to indicate whether to use the partial transform setting for the current block. If the flag indicates to use, an index is signalled to indicate which sub-setting (in each sub-embodiment under the partial transform setting) is used for the current block.

In another embodiment, whether to support the functionality of the proposed transform mode depends on high-level syntax. For example, a syntax at tile, slice, picture, SPS, or PPS (Picture Parameter Set) level. In one case, the syntax is shared with other non-block-vector coding tools. In another case, the syntax is independent of other non-block-vector coding tools.

In another embodiment, transform skip mode can be one of transform modes for the current block, which uses the scheme of intra block copy to generate the predictors for the current block. The maximum size of transform skip mode here can be indicated with a high-level syntax. For example, a syntax at tile, slice, picture, SPS, or PPS level. In one case, the syntax is shared with other non-block-vector coding tools. In another case, the syntax is independent of other non-block-vector coding tools.

In one sub-embodiment, the high-level syntax is individual from other high-level syntax of indicating the maximum size of transform skip mode. For example, the high-level syntax of indicating the maximum size of transform skip mode for mode type inter, mode type intra, and/or mode type IBC (a third mode type) is separate.

In another embodiment, when IBC uses vertical or horizontal BV (BV_x=0 or BV_y=0) or the referencing samples being horizontal-oriented or vertical-oriented, BDPCM is applied to the quantized residual values, where \tilde{r}_{i,j} is predicted from its neighbouring quantized residual value. For vertical IBC BDPCM prediction mode, for 0≤j≤(N−1), the following is used to derive \tilde{r}_{i,j}:

$${\tilde{r}}_{i , j} = \{ \begin{matrix}Q ( {r}_{i , j} ) , & i = 0 \\ Q ( {r}_{i , j} ) - Q ( {r}_{( i - 1 ) , j} ) , & 1 \leq i \leq ( M - 1 )\end{matrix} .$$

In another embodiment, the proposed transform mode refers to an inheriting transform setting. The inheriting transform setting means to support inherited transform candidates for the current block. An example for the case of IBC is shown as follows. One or more inherited transform candidates are inherited from the IBC reference blocks. The most popular K inherited transform candidates are available for the current block, where K is 1, 2, or any pre-defined positive integer. One from the K inherited candidates is selected as the transform mode for the current block. In one embodiment, several proposed transform candidates with the inheriting transform setting are included in a transform set and/or the transform set provides the transform mode for the current block.

In one sub-embodiment, for IBC merge/inter mode (for example, IBC merge and/or IBC AMVP), the reference blocks refer to the block providing the block vector information for the current block.

In another sub-embodiment, the reference blocks are indicated by the block vector (of an IBC block) or template-matching (of an intra TMP block). In addition to deriving the predictors for the current block, the reference blocks also provide the transform information for the current block.

In another sub-embodiment, setting of inheriting transform depends on the coding information of RR-IBC. For example, when the current block is using RR-IBC, the transform types are flipped. For another example, when the current block is using RR-IBC, the transform types for horizontal and vertical directions are swapped. For another example, when the current block is using RR-IBC, the transform mode selection is different from other coding modes.

In another embodiment, the proposed transform modes support all or any subset of JCCR (joint coded residuals/coefficients for Cb and Cr) modes. An example of mapping between tu_cbf_cb/tu_cbf_cr and reconstruction of Cb and Cr residuals is shown in Table 7.

TABLE 7
An example of mapping between tu_cbf_cb/tu_cbf_cr and reconstruction of Cb
and Cr residuals

| | | | TuCResMode |
|---|---|---|---|
| | | | (e.g., referring |
| | | | to different |
| tu_cbf_cb | tu_cbf_cr | reconstruction of Cb and Cr residuals | JCCR modes) |
| 1 | 0 | resCb[x][y] = resJointC[x][y] | 1 |
| | | resCr[x][y] = (CSign * resJointC[x][y]) >> 1 | |
| 1 | 1 | resCb[x][y] = resJointC[x][y] | 2 |
| | | resCr[x][y] = CSign * resJointC[x][y] | |
| 0 | 1 | resCb[x][y] = (CSign * resJointC[x][y]) >> 1 | 3 |
| | | resCr[x][y] = resJointC[x][y] | |

In another embodiment, whether to apply the proposed transform mode to the current block depends on a block-level syntax.

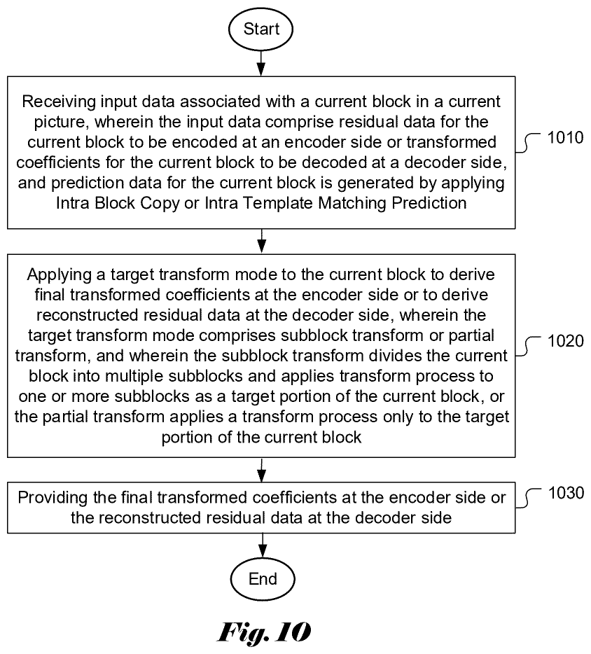

In another embodiment, down/up-sampling IBC modes are proposed as follows. When down/up-sampling IBC mode is used for the current block, the reference block indicated by block vectors is larger/smaller than the current block, the reference samples are down/up-sampled and then used to predict the current block. FIG. 9 illustrates an example of down-sampling IBC mode, where the current block 920 uses the reference block 930 in the current picture 910 to generate IBC predictor. The current block size is (W, H) and the reference block size is (kW, kH). Therefore, the reference block is k:1 down-sampled before being used as a predictor.

The proposed methods in this invention can be enabled and/or disabled according to implicit rules (e.g. block width, height, or area) or according to explicit rules (e.g. syntax on block-level or high-level such as tile, slice, picture, SPS, or PPS level). For example, the proposed method is applied when the block area is smaller/larger than a threshold. For an example of using a MTS-type transform mode for the current block which uses block vectors to generate prediction and/or is coded using a block-vector coding tool, the proposed transform mode referring to using the MTS-type transform mode for the current block is only allowed for a sub-mode of the block-vector coding tool. The sub-mode of the block-vector coding tool can be IBC-CIIP, IBC-GPM, IBC-LIC, IBC-MBVD, RR-IBC, IBC merge, IBC AMVP (or called as IBC inter), and/or any sub-mode of IBC or intraTMP. The sub-mode of the block-vector coding tool (for example, IBC, IBC merge, IBC inter, or intraTMP as the root mode) may be any optional mode which can be used/signalled if the root mode is enabled/applied. For an example of using a MTS-type transform mode for the current block which uses block vectors to generate prediction and/or is coded using a block-vector coding tool, the proposed transform mode referring to using the MTS-type transform mode for the current block is only allowed when the width, height, and/or area of the current block is smaller than a pre-defined threshold.

The term “block” in this invention can refer to TU/TB, CU/CB, PU/PB, pre-defined region, or CTU/CTB.

Any combination of the proposed methods in this invention can be applied.

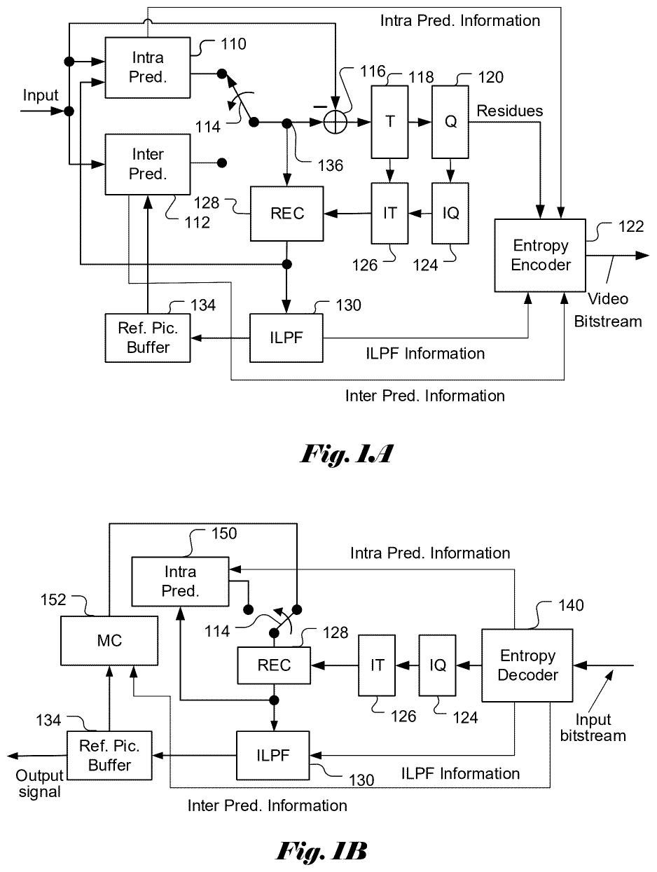

Any of the foregoing proposed methods can be implemented in encoders and/or decoders. For example, any of the proposed methods can be implemented in an inter/intra/IBC/prediction/transform module (e.g. Intra Pred. 110/Inter Pred. 112/Transform 118/Inverse Transform 126 in FIG. 1A) of an encoder, and/or an inter/intra/IBC/prediction/inverse transform module (e.g. Intra Pred. 150/MC 152/Inverse Transform 126 in FIG. 1B) of a decoder. Alternatively, any of the proposed methods can be implemented as a circuit coupled to the inter/intra/IBC/prediction/transform module of the encoder and/or the inter/intra/IBC/prediction/(inverse) transform module of the decoder, so as to provide the information needed by the inter/intra/IBC/prediction/transform module (e.g., transform module or inverse transform module). While the involved modules (e.g. unit 110/112/118/126 in FIG. 1A or unit 150/152/126 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 10 illustrates a flowchart of an exemplary video coding system that uses multiple transforms for IBC/IntraTMP mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to the method, input data associated with a current block in a current picture are received in step 1010, wherein the input data comprise residual data for the current block to be encoded at an encoder side or transformed coefficients for the current block to be decoded at a decoder side, and prediction data for the current block is generated by applying Intra Block Copy or Intra Template Matching Prediction. An target transform mode is applied to the current block to derive final transformed coefficients at the encoder side or to derive reconstructed residual data at the decoder side in step 1020, wherein the target transform mode comprises subblock transform or partial transform, and wherein the subblock transform divides the current block into multiple subblocks and applies transform process to one or more subblocks as a target portion of the current block, or the partial transform applies a transform process only to the target portion of the current block. The final transformed coefficients at the encoder side or the reconstructed residual data at the decoder side are provided in step 1030.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block in a current picture, wherein the input data comprise residual data for the current block to be encoded at an encoder side or transformed coefficients for the current block to be decoded at a decoder side, and prediction data for the current block is generated by applying Intra Block Copy or Intra Template Matching Prediction;
applying a target transform mode to the current block to derive final transformed coefficients at the encoder side or to derive reconstructed residual data at the decoder side, wherein the target transform mode comprises subblock transform or partial transform, and wherein the subblock transform divides the current block into multiple subblocks and applies transform process to one or more subblocks as a target portion of the current block, or the partial transform applies a transform process only to the target portion of the current block; and
providing the final transformed coefficients at the encoder side or the reconstructed residual data at the decoder side.

2. The method of claim 1, wherein when the target transform mode corresponds to the subblock transform, the target portion corresponding to one of the multiple subblocks is selected as one of transform blocks to apply the transform process.

3. The method of claim 1, wherein a quadtree is used to divide the current block into 4 subblocks.

4. The method of claim 1, wherein the target portion is selected using implicit definition or explicit signalling.

5. The method of claim 1, wherein a binary tree is used to divide the current block into 2 subblocks.

6. The method of claim 5, wherein the 2 subblocks are equal-sized or unequal-sized.

7. The method of claim 6, wherein the target portion is indicated by a smaller one of unequal-sized subblocks.

8. The method of claim 1, wherein splitting direction, the target portion, or both are indicated by implicit definition or explicit signalling.

9. The method of claim 1, wherein when the target transform mode corresponds to the subblock transform, residuals in non-target portion of the current block are zeroed out or coefficients in non-target portion of the current block are zero.

10. The method of claim 1, wherein when the target transform mode corresponds to the partial transform, the target portion follows a pre-defined partitioning line.

11. The method of claim 10, wherein residuals around the pre-defined partitioning line are scanned and put into the target portion at the encoder side or coefficients associated with the target portion are scanned.

12. The method of claim 1, wherein when the target transform mode corresponds to the partial transform, the target portion corresponds to one transform block.

13. The method of claim 1, wherein when the target transform mode corresponds to the partial transform, residuals in non-target portion of the current block are zeroed out or coefficients in non-target portion of the current block are zero.

14. The method of claim 1, wherein usage of the target transform mode is indicated as an additional transform option by explicit signalling.

15. The method of claim 1, wherein the target transform mode is enabled if one or more enabling conditions are satisfied.

16. The method of claim 15, wherein said one or more enabling conditions comprise the target transform mode being available for one or more sub-modes of a target block vector coding tool.

17. The method of claim 16, wherein the target block vector coding tool corresponds to IBC merge mode or IBC inter mode.

18. The method of claim 15, wherein said one or more enabling conditions comprise the target transform mode being available for blocks with size condition satisfied.

19. The method of claim 15, wherein said one or more enabling conditions comprise whether to support functionality of the target transform mode depending on high-level syntax.

20. An apparatus for video encoding, the apparatus comprising one or more electronics or processors arranged to:
receive input data associated with a current block in a current picture, wherein the input data comprise residual data for the current block to be encoded at an encoder side or transformed coefficients for the current block to be decoded at a decoder side, and prediction data for the current block is generated by applying Intra Block Copy or Intra Template Matching Prediction;
apply an target transform mode to the current block to derive final transformed coefficients at the encoder side or to derive reconstructed residual data at the decoder side, wherein the target transform mode comprises subblock transform or partial transform, and wherein the subblock transform divides the current block into multiple subblocks and applies transform process to one or more subblocks as a target portion of the current block, or the partial transform applies a transform process only to the target portion of the current block; and
provide the final transformed coefficients at the encoder side or the reconstructed residual data at the decoder side.
